(19) United States
(12) Patent Application Publication
(10) Pub. No.: US 2023/0031272 A1
(43) Pub. Date: Feb. 2, 2023

(54) ACCURATE INDEPENDENT 2-DOF SUN-TRACKING DEVICE

(71) Applicants: Byung Man KWAK, Seongnam-si (KR); Joon Young KWAK, Seoul (KR); Kyung Woon KWAK, Daejeon (KR)

(72) Inventors: Byung Man KWAK, Seongnam-si (KR); Joon Young KWAK, Seoul (KR); Kyung Woon KWAK, Daejeon (KR)

(21) Appl. No.: 17/673,662

(22) Filed: Feb. 16, 2022

(30) Foreign Application Priority Data
Feb. 18, 2021 (KR) 10-2021-0021814
Mar. 9, 2021 (KR) 20-2021-0000750

(51) Int. Cl. H02S 20/32

(52) U.S. Cl. CPC H02S 20/32

(57) ABSTRACT

This disclosure relates to exact sun-tracking devices by the principle of exact sun-following by independent 2-DOF, which says if the daily rotation axis is installed on a ground structure in parallel with the earth's rotation axis and the elevation angle axis is mounted perpendicularly to the daily rotation axis then the two rotational degrees of freedom are independent of each other. This property makes a separate intermittent control with a forward half-step setting very efficient and energy-saving. A control system by a wire loop driving mechanism has several advantages, holding the structure securely, relieving a motor weight from the over-structure, and allowing a simple economic control with self-locking. Three structural types are categorized: a long shaft type, a tip-tilt type, and a tension structure type. An array sun-tracking device with an efficient wire loop actuating mechanism illustrates a preferred sun power generation system for general and industrial applications.

### CROSS-REFERENCE TO RELATED APPLICATIONS

The present application is related to two Korean patent applications by the applicant as follows and claims priority:

1) Application number: 10-2021-0021814 (DAS code: 5456)
Filing date: Feb. 18, 2021
Title: Accurate Independent 2-DOF Sun-Tracking Device

2) Application number: 20-2021-0000750 (DAS code: C145)
Filing date: Mar. 9, 2021
Title: Accurate Sun-Tracking Device for PV Arrays.

This specification is a translated version of the said applications combined and rewritten to enhance clarity and details.

References searched by the applicant are:

Patent number: U.S. Pat. No. 10,168,412 B2 (Jan. 1, 2019)

Patent number: U.S. Pat. No. 8,895,836 B2 (Nov. 25, 2014)

Patent number: U.S. Pat. No. 4,172,739 (Oct. 30, 1979)

Non-patent: Singh, R., Kumar, S., Gehlot, A., and Pachauri, R., An Imperative Role of Sun Trackers in Photovoltaic Technology: A Review, Renewable and Sustainable Energy Reviews, 82(2018) 3263-3278.

### BACKGROUND OF THE INVENTION

The present disclosure relates to an apparatus capable of accurately tracking the sun concerning solar power generation using two degrees of freedom independent of each other.

Among existing solar power generation systems are devices that fix in one posture, adjust only one axis for rotation, or control two axes for solar tracking. However, the two degrees of freedom adopted in most two-axis sun trackers are not independent. In this case, two drive motors operate at the same burden, and the control method is complicated, usually using sensors. Also, solar panels of most of the existing dual-axis devices are supported at one point, and so the structural weight increases to design against stress concentration and disturbances such as wind. Despite the complexity and price of such devices and controls, two-axis solar power generation devices are getting preferred considering their high efficiency and overall performance.

### BRIEF SUMMARY OF THE INVENTION

The purpose of this disclosure is to provide solar tracking devices, which can be simply controlled without sensors to accurately follow the sun while keeping robustness and stability against disturbances such as wind.

The present invention utilizes a principle to achieve accurate solar tracking by using a simple control method. The tracking device by this principle will have two axes of rotation: the first rotation axis which is the daily rotation axis is installed on a ground structure at the site of solar power generation, parallel to the axis of the earth's rotation, which is the same direction to the Polar Star, and the second rotation axis which is an elevation angle axis is mounted on the frame of the first rotation axis such that it is perpendicular to the first rotation axis. Then the said principle says that the two rotational degrees of freedom are independent of each other. That is, any daily rotation about the first rotation axis does not influence the elevation angle about the second rotation axis. This property brings in an advantage in control and economic operation. The essential conditions of the principle are that the first rotation axis is fixed on the earth and parallel to the axis of the earth's rotation, and the second axis is installed on the frame of the first axis and perpendicular to the first axis.

Among the devices of dual-axis systems of prior arts, either the first axis is vertically installed on the earth's surface, or instead of the axis of daily rotation, the axis for the elevation angle is fixed on the earth's surface. Thus, most sun trackers of prior arts do not allow independent control and any control methods for the coupled DOF (Degree of Freedom) become complex.

Since the said principle is unknown or not explicitly identified in the literature, this principle is to be called here the “Principle of Exact Sun-following by Independent 2-DOF.” Although this principle may be proven by using some complex spherical geometry, this can be explained simply as follows. Consider a time say solar noon when the sun reaches the solar culmination, and a solar panel of the present invention is set perpendicular to the sunlight. One hour later the earth rotates by 15 degrees toward the east and then the solar panel rotates by the same 15 degrees with the earth. Now let the solar panel rotate by the same amount toward the west around the first rotation axis, which is parallel to the axis of earth's rotation, then the solar panel looks at the sun exactly as one hour ago. That is, even though the earth rotates toward the east, the solar panel keeps perpendicular to the sun if the solar panel is rotated back toward the west by the same amount of earth's rotation, which is the daily rotation. Since the elevation angle of the solar panel is not influenced by the daily rotation, the said elevation angle can be controlled independently of the daily rotation.

The range of elevation angle is 46.9 degrees, that is, from −23.45 at the winter solstice to 23.45 at the summer solstice. This range is covered by the elevation angle axis in 6 months, which is a very slow motion. It is very reasonable to adjust the elevation angle intermittently, for example once every month at the time of a regular maintenance. In this case, the irradiation energy loss, the so-called cosine effect, is about 0.23% compared with the maximum irradiation energy at a perpendicular incident angle.

The range of rotation around the daily rotation axis is from dawn to sunset. If the daily rotation angle is adjusted every 30 minutes on the hour to the sun position corresponding to the time 15 minutes after the adjustment time, the irradiation energy loss is about 0.22%. This is an intermittent open-loop control with a forward half-step setting and reduces the loss of efficiency to about one-fourth as compared to an on-time setting. As an illustrative embodiment, it is reasonably sufficient to set a daily rotation from 5 hours before noon to 5 hours afternoon depending on the location.

The basic mechanism of devices realizing the principle of exact sun-following takes a form of a 2-axis gimbal. The rotation axis of the outer gimbal corresponds to the daily rotation axis installed parallel to the earth's axis and the inner gimbal axis to the elevation angle axis. Four preferred embodiments are disclosed: A long shaft type, a tip-tilt type, a tension structure type, and an array form. The daily rotation axis of the long shaft type has a distance between its bearings supported by two distinct poles or columns. If the distance is small such that the two poles merge in one pole, then a tip-tilt type is obtained. Accordingly, the solar panel with its mounting frame is supported at one point. The structural shape of this type tends to be overly weighted and vulnerable to external disturbances such as wind, compared to other types. A supporting structure for a solar panel can be designed better with multiple supports than with single support in terms of lightweight.

One embodiment of a driving mechanism for the daily rotation axes of the long shaft type and the tension structural type is to use a wire loop and a linear actuator such as a worm-gear motor. This embodiment of the said driving mechanism is simple and increases stability and robustness against disturbances such as wind, unbalanced weight, and so on.

### BRIEF DESCRIPTION OF THE DRAWINGS

FIG. 1 is a schematic side view of an independent 2-DOF long shaft type,

FIG. 2 is a schematic side view of an independent 2-DOF tip-tilt type,

FIG. 3 is a perspective view of an independent 2-DOF tension structure type,

FIG. 4 is a schematic side view of an array sun tracker.

### DETAILED DESCRIPTION OF THE INVENTION

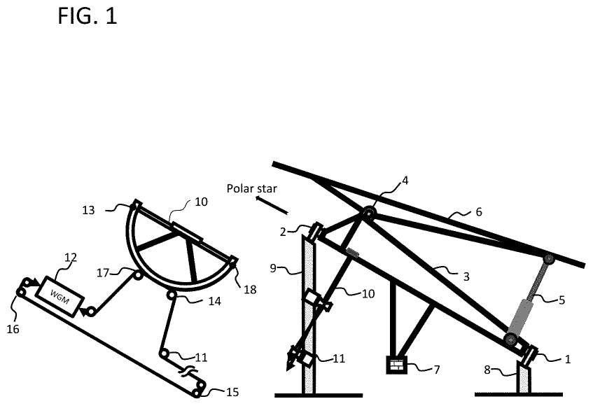

Desirable embodiments of the present invention are described using FIG. 1 through FIG. 4. FIG. 1 is an embodiment of a long shaft type, showing two rotation axes perpendicular to each other and a wire loop system as a driving mechanism. A daily rotating frame 3 is supported by bearings 1 and 2 to form the daily rotation axis. Bearings 1 and 2 are installed on the south column 8 and the north column 9, respectively such that the daily rotation axis is parallel to the earth's rotation axis. The earth's rotation axis is toward the Polar Star when in the northern hemisphere. The daily rotating frame 3 is driven by a driving mechanism comprising a linear actuator such as a worm-gear motor 12, a drive wheel 10 fixed to the daily rotating frame 3, and a wire loop surrounding the drive wheel 10. The worm-gear motor 12 comprises a worm, worm gear, a motor, and a wire winding cylinder to pull the wire of the said wire loop back and forth. The wire loop starts from point 13 on the drive wheel 10, goes through a circular groove of the drive wheel 10, guide rollers 14, 15, 16, and 17, and ends at point 18 on the said drive wheel. This is a crossed wire layout. The guide rollers are fixed on a structure that is installed on the ground. It is not drawn in the figure. The worm-gear motor mechanism 12 is irreversible or self-locking and so the daily rotating frame remains stationary at any position without power consumption. The center of the drive wheel 10 is positioned on the said daily rotation axis and the shape of the drive wheel has a circular arc with a groove. This keeps the length of the wire loop constant regardless of the angular position of the drive wheel 10. It is noted that a balancing weight 7 may be necessary to compensate for the offset weight of the rotating parts such as the solar panel frame 6 and the daily rotating frame 3.

The solar panel frame 6 is mounted on the daily rotating frame 3 by an elevation angle hinge 4 and one or more length adjusting device 5. The elevation angle hinge 4 is perpendicular to the daily rotation axis. A length adjusting device 5 has two hinges or spherical joints at its ends: one attached on the daily rotating frame 3 and the other on the solar panel frame 6. More than two length adjusting devices 5 may be installed to support the solar panel frame 6. Multi-point support is very advantageous in terms of lightweight structural design compared to single-point support as in a tip-tilt type. This may be intuitively seen by considering load shares for single-point support and multi-point support. An optimum structural design, which is a desirable practice for real applications, will show this also. The elevation angle can be adjusted manually with little loss of efficiency as explained in the previous section. It is obvious that it can be controlled by a motor or a solenoid installed within the length adjusting device. Also, the driving power in this latter case is less than that for directly actuating a shaft by a motor as required in a tip-tilt type, due to a leveraging effect of the distance between the elevation angle hinge 4 and the length adjusting device 5.

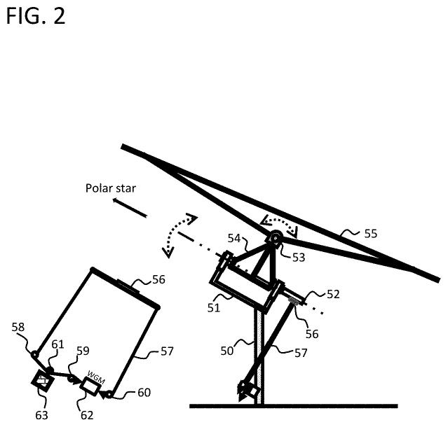

FIG. 2 is an embodiment of a tip-tilt type of the present invention. The configuration of a tip-tilt type can be obtained by merging the two columns, or by reducing the distance of the supporting bearings 1 and 2 of the long shaft type in FIG. 1. This is an embodiment where the daily rotating frame 54 is installed on an outer gimbal 51 that is supported by single point at the tip of column 50 and the elevation angle frame or the solar panel frame 55 is hinged on top of the daily rotating frame 54. The daily rotation axis 52 is parallel to the earth's rotation axis, and the hinge 53 for the elevation angle is perpendicular to the daily rotation axis 52, and therefore conforms to the principle of exact sun-following by independent 2-DOF. In most of the conventional tip-tilt two-axis trackers of prior arts, instead of the daily rotation axis, the elevation angle axis is installed on the ground, or the first rotation axis is vertically installed, not satisfying the two conditions in the said principle adopted in the present invention. Tip-tilt type structures of prior arts have disadvantages over multiple point or area supported structures in terms of structural integrity, especially when the size is large or of industry size.

A wire loop mechanism of a crossed wire layout like the one illustrated for the long shaft type in FIG. 1 may well be applied to the tip-tilt type of FIG. 2. In the present embodiment, however, a non-crossed wire layout is shown in FIG. 2. A drive bar 56 is mounted perpendicularly on the daily rotation axis 52. A wire loop 57 surrounds a plurality of roller guides 58, 59, and 60 that are fixed on a ground structure, which is not drawn in FIG. 2. A worm-gear motor 62 actuating the said wire loop is installed on the said ground structure. Not like the crossed wire layout shown in FIG. 1, in the non-crossed wire layout illustrated in FIG. 2 the length of the wire loop changes with the rotation angle. Therefore any looseness or tightness of the wire should be absorbed keeping appropriate tension. One such mechanism using a tensioning weight 63 is illustrated in FIG. 2. The tensioning weight 63 is hung from a movable pulley 61. Of course, other mechanisms using a spring for example will also serve the same purpose. This addition of the wire loop actuating mechanism instead of directly driving the daily rotation axis gives a great advantage of holding the structure securely and relieving the motor weight from the over-structure supported by column 50. Of course, the location and detailed design of the actuating mechanism depends on applications.

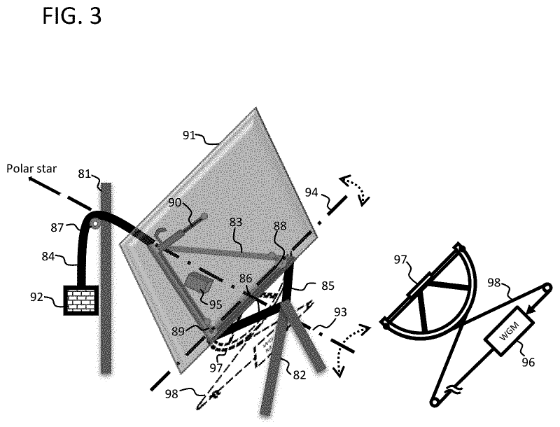

FIG. 3 shows an embodiment of a tension structure type with two perpendicular rotation axes and an actuator device using a wire loop. The daily rotating frame 83 is supported by three ropes 84, 85, and 86. One end of the rope 84 is attached to the daily rotating frame 83 through a pulley 87 that is fixed on the north column 81 and the other end of the rope 84 carries a tensioning weight 92 to maintain a constant tension in the rope. Ropes 85 and 86 are fixed at a point of a south structure 82, such that the daily rotation axis 93 is parallel to the earth's rotation axis. The daily rotating frame 83 rotates around the daily rotation axis 93 by an actuator mechanism comprising a worm-gear motor mechanism 96, a drive wheel 97, and a wire loop 98. The said actuator mechanism is the same as the crossed wire actuator mechanism explained for the long shaft type in FIG. 1. The drive wheel 97 of the actuator mechanism is installed on the underside of the daily rotating frame 83 to be normal to the said daily rotation axis 93 with its center located on the said axis. The worm-gear motor (WGM) 96 can pull the rope 98 back and forth to rotate the drive wheel 97 and accordingly the daily rotating frame 83. The shape of the drive wheel has a half-circular arc so that the length of the wire loop 98 is kept constant for any rotation angle. It is noted that an appropriate balancing weight may be installed to compensate for the offset weight due to the solar panel frame 91 and the daily rotating frame 83. The balancing weight is not drawn in FIG. 3.

A solar panel frame 91 is supported by hinges 88 and 89 that are installed on the south side of the daily rotating frame 83 and a length adjusting device 90 that is installed on the north side of the daily rotating frame 83. The length adjusting device 90 may be actuated by a motor or a solenoid, but as explained earlier this can be adjusted manually say once a month using a linear indexing mechanism. Since the solar panel frame 91 has a range of movement of ±23.45° its installation must secure appropriate space to avoid any interference with neighboring parts. This means that the hinges 88 and 89 need to be installed with some height from the daily rotating frame 83.

In case of a harsh environment with dust, a vibrator 95 may be installed in an appropriate place on the solar panel frame or the daily rotation frame and actuated to remove dust on the solar panel. The flexibility of ropes allows maximum use of the vibrating power for dusting.

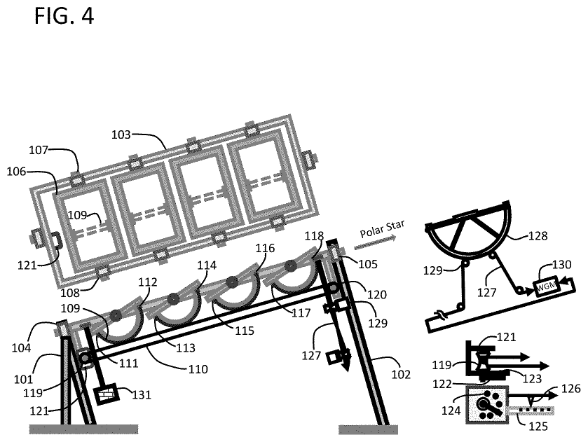

FIG. 4 shows an embodiment of an array sun-tracking device according to the principle of exact sun-following by independent 2-DOF. The general shape of the device is a two-axis gimbal, having an external gimbal frame and one or multiple inner gimbal frames. The daily rotating frame 103 corresponding to the external gimbal frame is installed parallel to the earth's rotation axis through two bearings 104 and 105 on a south column structure 101 and a north column structure 102, respectively. A solar panel frame 106 corresponding to an inner gimbal frame is installed on the daily rotating frame 103 through bearings 107 and 108. Similarly, an array of solar panel frames can be installed on the said daily rotating frame, as illustrated in FIG. 4, where four solar panel frames are shown. These solar panel frames must keep some appropriate distance between each other such that the shade of a solar panel in front should not cover any part of other solar panels.

The elevation angle of the solar panel frame 106 can be adjusted by a drive wheel 109 mounted perpendicularly underneath the solar panel frame. A wire loop 110 connects all the drive wheels in the said array and makes them move in unison by activating a position locking device 121. The drive wheels have a circular arc with a groove. The wire loop 110 has crossed wire layouts. This keeps the length of the wire loop constant regardless of the angular position of the drive wheels. With some other wire layouts, another device that can absorb looseness or tightness of the wire loop may be necessary.

FIG. 4 illustrates an array of four solar panel frames. The connection of the wire loop 110 is explained using this layout. The wire loop 110 starts from point 112 fixed on the drive wheel 109, follows the circular groove of the said wheel, passes a wire winding cylinder 119 and a guide roller 120, and attaches to a fixed point 117. Another piece of the wire loop is connected between the fixed points 118 and 115 through the circular grooves on the corresponding drive wheels. Two fixed points 116 and 113 and another pair of fixed points 114 and 111 are similarly connected through corresponding circular grooves. The wire winding cylinder 119 can be wound or unwound by a winding handle 122 to the desired elevation angle. It is noted that a reduction gear system may be inserted between the wire winding cylinder 119 and the winding handle 122 to reduce the handling force. The wire loop is held stopped by inserting a handle stop pin 123 into a handle stop hole 124. A set of handle stop holes 124 are arranged to match the desired set of positions 125 using a position indicator 126. As an illustration, if the elevation angle is to be adjusted once a month, the number of holes necessary is six because the elevation history from the winter solstice to the summer solstice takes the same positions between the summer solstice and the winter solstice. It is easily conceived that instead of using a wire loop, a chain loop can be utilized with the same purpose. One embodiment is as follows. In the case of a chain, however, the loop connection is different. Instead of half-circular grooves of drive wheels and the wire winding cylinder119, sprockets are used. The said chain is one piece surrounding sprockets 119 and 120 and connecting all the sprockets of the drive wheels. It is not drawn in FIG. 4.

The control of the daily rotation angle can be made in a similar way as illustrated for the long shaft type or the tip-tilt type using a wire loop. A crossed wire layout is shown in FIG. 4. A drive wheel 128 is installed underneath the daily rotating frame 103 perpendicularly to the daily rotation axis through bearings 104 and 105 with its center on the said rotation axis. The drive wheel 128 is driven by a wire loop 127 around a circular groove of the drive wheel, passing through a plurality of roller guides such as 129 and equipped with a worm-gear motor 130. The said roller guides are installed on a ground structure or on the north structure 102. It is noted that the bearings 107 and 108 for the elevation angle frame 106 can be mounted on the daily rotating frame 103 with some height depending on some particular design, to reduce any offset weight of rotating parts. It may be desirable to add a counterweight 131, even though the wire loop 127 holds the rotating parts of the structure tight.

It is obvious to easily connect an array of sun trackers of the type in FIG. 4 by using an extended wire loop as explained for the wire loop mechanism for adjusting the elevation angle of the array of the solar panel frames.

The wire loop actuating mechanisms illustrated as desirable embodiments in the present disclosure have several advantages over other actuator mechanisms in prior arts. In addition to connecting an array of solar trackers or solar panel frames and driving them simultaneously by one motor, the wire loop tightly holds moving parts of structures against wind or other disturbing loads, which enhances structural integrity such as stability and safety. Also, the worm-gear motor (WGM) adopted is self-locking and very suitable for intermittent control. This can be located at a convenient place without increasing dead load to the moving part of the structure.

In the description, a wire denotes an illustrative term and may mean rope, wire rope, string, etc. Other position control mechanisms such as a rack and pinion or a lead screw are also possible for similar purposes but maybe without self-locking capability.

For an intermittent open-loop control driving the devices of the present invention, a sequence of preset times is initialized and stored. When a preset time comes, a clock timer gives a signal to actuate a motor by a preset angle increment obtained from the number of intermittent steps. The sequence of the preset times is arranged referring to the solar noon time from the clock. It is noted that there are some differences between the solar noon from clock time and from sun time. The solar noon from sun time can be obtained from the equation of time and may well be utilized for the present intermittent control. However, since the maximum difference between the two times for solar noon is about 16 minutes in September, the clock time may well be used for a set of daily rotation angular positions that can be used year-round, because the maximum loss of irradiation efficiency is about 0.24%. It is also noted that the time difference is about 4 minutes from March to September when sunshine is relatively strong. For the intermittent control, presume a daily operation time from 7 am to 5 pm actuating intermittent controls on the hour, then at 7 am, the daily rotation angle is controlled to the earth's rotation angle corresponding to the clock time 7:30 am instead of 7:00 am. This forward half-step setting reduces the loss of efficiency to about one-fourth of that without forward setting and is a great advantage over the on-time setting.

After an intermittent control is completed, the motor is turned off until the next control time. After the last control step at 5 pm, a control step is taken to bring the daily rotating frame back to the daily rotation angle corresponding to the time 7:30 am.

Although specific layouts and means for practicing the present invention for a long shaft type, a tip-tilt type, a tension structure type, and an array sun tracker have been described herein and illustrated in the accompanying drawings, they are only for purposes of illustration and the scope of the invention is not limited thereby but is to be determined from the context of the concepts. Further, since numerous modifications and variations will readily occur to those skilled in the art, it is not desired to limit the invention to the exact construction and operation illustrated and described, and, accordingly, all suitable modifications and equivalents may resort to that fall within the scope of the invention.

1. A two-axis solar tracking device, comprising:
a daily rotation axis with a daily rotating frame that is installed on a ground structure and parallel to the earth's axis of rotation,
an elevation angle axis with a solar panel frame that is installed on the daily rotating frame and perpendicular to the daily rotation axis by the principle of exact sun-following by independent 2-DOF,
a driving mechanism for the daily rotation,
a driving mechanism for the elevation angle, and
an intermittent open-loop control with a forward half-step setting.

2. A two-axis solar tracking device of claim 1, wherein the daily rotation axis with a daily rotating frame is supported by two bearings mounted on the south and the north column or similar structure, respectively, to be called a long shaft type, and the elevation angle axis with the solar panel frame is actuated by hinges and a plurality of linear actuators or length adjusting devices.

3. A two-axis solar tracking device of claim 1, wherein the daily rotation axis with the daily rotating frame supported by one or more bearings that are mounted on a column or similar structure, to be called a tip-tilt type, and the elevation angle axis with the solar panel frame is actuated by one hinge with a motor or one hinge and two or more linear actuators or length adjusting devices. The daily rotation axis is driven by a wire loop actuating mechanism comprising a driving bar, a wire loop, a linear actuator such as a worm-gear motor, and a tensioning weight.

4. A two-axis solar tracking device of claim 1, wherein the daily rotation axis with the daily rotating frame is supported by three or more wires attached to a north and south column or similar structure, where one of the wires in the north column is kept under constant tension, so to be called a tension structure type, and the elevation angle axis with the solar panel frame is actuated by a hinge and two or more linear actuators or length adjusting devices.

5. A two-axis solar tracking device of claim 1, wherein the driving mechanism for the daily rotation axis comprises a driving wheel with a circular groove, a wire loop, and a linear actuator such as a worm-gear motor.

6. A two-axis solar tracking device of claim 1, wherein an intermittent open-loop control with a forward half-step setting actuates an actuator with a preset frequency of stepping, for example, every hour on the hour to a position corresponding to a half-step ahead, which reduces loss of irradiation efficiency dramatically compared with that without a forward half-step setting.

7. A two-axis array solar tracking system, comprising:
a daily rotation axis with a daily rotating frame that is installed parallel to the earth's axis of rotation,
an array of solar panel frames whose elevation angle axes are mounted perpendicularly to the daily rotation axis by the principle of exact sun-following by independent 2-DOF,
a driving mechanism for the array of solar panel frames that connects all the said solar panel frames and makes them rotate simultaneously, comprising drive wheels, a wire loop, a position locking device, and a plurality of guide rollers,
a driving mechanism for the daily rotating frame comprising a driving wheel with a circular groove, a wire loop, and a linear actuator such as a worm-gear motor,
a control system by an intermittent open-loop control with a forward half-step setting for the daily rotation using a wire loop or a chain loop actuating mechanism, and
a manual adjustment system using an index plate or a similar for the elevation angle rotation.
